(19) United States
(12) Patent Application Publication
(10) Pub. No.: US 2005/0259291 A1
(43) Pub. Date: Nov. 24, 2005

(54) ELECTRONIC NEWS SYSTEM AND RECORDING MEDIUM TO BE USED THEREFOR

(76) Inventors: TAKAHIRO KII, KAWASAKI-SHI (JP); KAZUHIRO OHISHI, KAWASAKI-SHI (JP); KYOKO OKUYAMA, KAWASAKI-SHI (JP); NAOMI IWAYAMA, KAWASAKI-SHI (JP)

Correspondence Address: STAAS & HALSEY LLP, SUITE 700, 1201 NEW YORK AVENUE, N.W., WASHINGTON, DC, 20005, US

(21) Appl. No.: 08/991,855

(22) Filed: Dec. 16, 1997

(30) Foreign Application Priority Data
Jun. 10, 1997 (JP) 9-152675

(51) Int. Cl. G06K 15/00

(52) U.S. Cl. 358/1.15

(57) ABSTRACT

The invention relates to an electronic news system of stand-alone type or network type for managing electronic messages and replies to the messages such as an electronic bulletin board system in which data for reply selected by the user from among indicated data for fixed form replies is transmitted as a reply, so that the input operation of the reply is easy and many replies can be obtained from the readers of the message, and also by totaling the number of the respective selections out of data of plural replies, the opinions on the messages can be processed in the form of being easily referred to for example in a bar graph style.

### BACKGROUND OF THE INVENTION

The present invention relates to an electronic news system of stand-alone type and client/server type for managing electronic messages and replies to the messages, and a recording medium on which a program for assisting an input of the reply to the message is recorded.

FIG. 1 shows a constitution diagram of a conventional client/server type electronic news system. The client apparatus 100 and the server apparatus 200 are connected by the computer network such as a personal computer communication network, the Internet and the like.

The client apparatus 100 is furnished with an input device 101 such as a keyboard and a mouse for inputting text data, a microphone for inputting speech sound signals, a scanner for scanning and reading still pictures, a video capture for inputting video signals of moving pictures, and the like, and an output device 102 such as a display, a printer, a speaker, etc. for outputting messages, and an output controller 103 controls data output to the output device 102. The transmission data holding unit 106 holds the message to be transmitted, and converts multimedia data into data with format which is receivable by the server apparatus 200, and the received data holding unit 107 holds the received messages. A network controller 105 controls communication with the network, and a main controller 104 controls operation of each part of the client apparatus 100 and receipt and delivery of data between the parts.

The server apparatus 200 is furnished with an electronic news data storage 221 for managing all messages including the messages posted by another server apparatus, replies and the like, a network controller 223 controls communication with the network, and a main controller 222 controls operation of each part of the server apparatus 200 and receipt and delivery of data between the parts.

The user of the client apparatus 100 can refer to the message posted to the server apparatus 200, and can transmit to the server apparatus 200 a reply to the referred message.

Also, the electronic news may be categorized by the topic such as scientific technique, social problem, hobby, etc.

In the meantime, even in case of transmitting a simple reply such as “I also agree”, “Very interesting, isn't it ?” to the poster of the message, the user of the client apparatus 100 has been required to use the input device 101 to input text data or to prepare multimedia data.

Also, due to such complexity of input operation of the reply, there has been a problem that the replies of the number enough to fairly judge the readers' opinions and thoughts on the message cannot be obtained, compared with the number of the message readers.

### BRIEF SUMMARY OF THE INVENTION

The present invention has been made to solve the above problems, and an object of the invention is to provide an electronic news system in which a reply input operation is simple to obtain many replies from the readers of the message by transmitting the data for a reply selected by the user from among the indicated data for a fixed form reply, and a recording medium in which the program to support the input of the reply to the message is recorded.

Another object of the invention is to provide an electronic news system in which, by totaling the number of the respective selections out of data for the plural replies, the opinions on the message can be processed in the form of being easily referenced for example in a bar graph style, and a recording medium in which a program for supporting the input of a reply to the message is recorded.

A further object of the invention is to provide an electronic news system which permits reference of a list of free form replies to each message by managing the free from reply to the message in relation to the specifying data of the message and a recording medium in which a program for supporting the input of a reply to the message is recorded.

The electronic news system and recording medium of the present invention are characterized in that data for a fixed form reply is stored, the data for a reply is outputted, and the selection out of the outputted data for replies is to be received as the reply to the message.

Accordingly, the user can transmit the reply only by making the selection out of the data for fixed form replies, and therefore many replies can be obtained from the message readers in simple reply input operation.

The electronic news system and recording medium of the present invention are characterized in that, the contents of data for a plurality of fixed form replies are managed by data for respectively specifying said data for the replies, the number of the selection of each reply as the reply to the message are totaled, and the results of the totalization of the data for each reply to the message are stored in relation to the specifying data of the message.

Accordingly, the opinions to the message can be processed into the form that is easy to be referred such as a bar chart.

Also, the electronic news system and recording medium of the present invention are characterized by accepting an input of a free form reply to the message, and managing the input free form reply in relation to data to specify said message.

Accordingly, the list of the free form replies to the individual messages can be referred.

The above and further objects and features of the invention will more fully be apparent from the following detailed description with accompanying drawings.

### BRIEF DESCRIPTION OF THE SEVERAL VIEWS OF THE DRAWINGS

FIG. 1 is a constitution view of a conventional electronic news system;

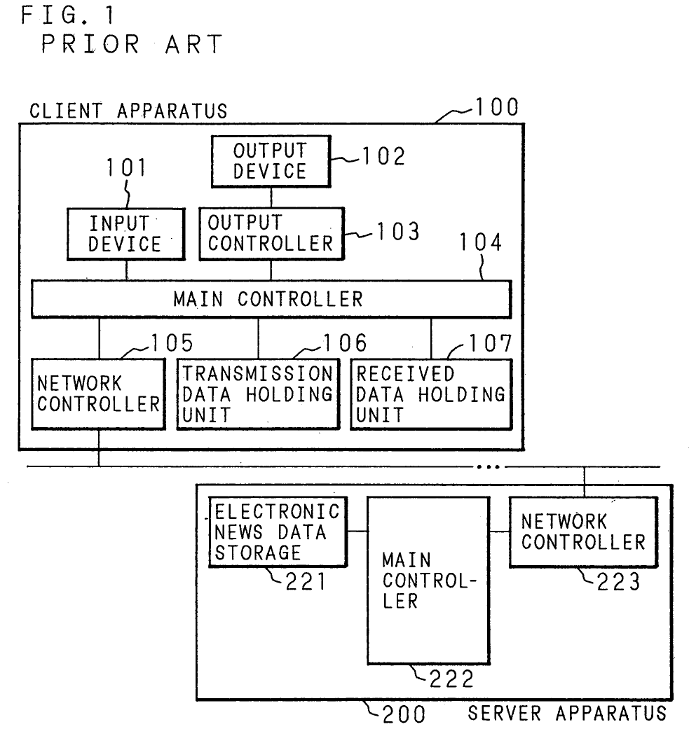

FIG. 2 is a constitution view of the system of Embodiment 1;

FIG. 3 is a constitution view of the system of Embodiment 2;

FIG. 4 is a flow chart of the procedures in Embodiment 2;

FIG. 5 is a view showing an example of screen display in Embodiments 1 and 2;

FIG. 6 is a flow chart showing an example of the procedures for referring replies in Embodiment 2;

FIG. 7 is a constitution view of the system of Embodiment 3;

FIG. 8 is a constitution view of the system of Embodiment 4;

FIG. 9 is a flow chart of the procedures in Embodiment 4;

FIG. 10 is a flow chart showing an example of the procedures for referring replies in Embodiment 4;

FIG. 11 is a conceptual view of the stored condition of the total list of the reply data;

FIG. 12 is a view showing an example of display of the results of the totalization of the reply data;

FIG. 13 is a constitution view of the system of Embodiment 5;

FIG. 14 is a constitution view of the system of Embodiment 6;

FIG. 15 is a conceptual view showing the stored condition of a brief reply;

FIG. 16 is a view of display of a brief reply;

FIG. 17 is a constitution view of the system of Embodiment 7; and

FIG. 18 is a constitution view of the system of Embodiment 8.

### DETAILED DESCRIPTION OF THE INVENTION

### Embodiment 1

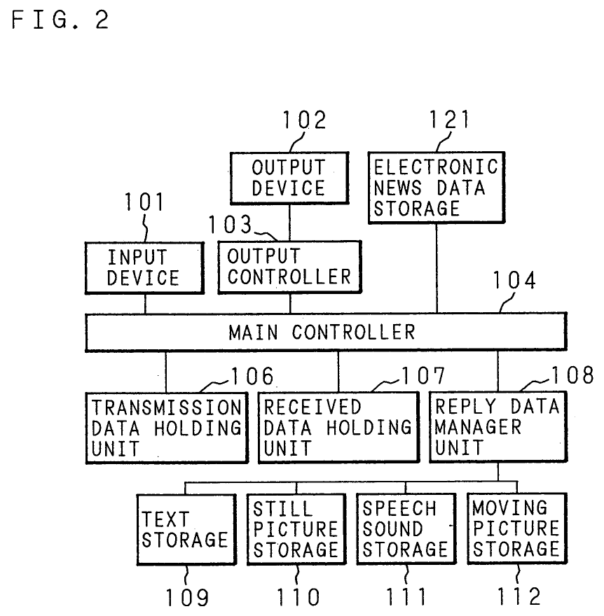

FIG. 2 is a constitution view of an example of the stand-alone type electronic news system of the present invention. With respect to the utilization style of the stand-alone type electronic news system, there can be conceived such a style that a single computer is utilized by a large number of students in a school.

The system comprises an input device 101, such as a keyboard and a mouse for inputting the text data, a microphone for inputting a speech sound signal, a scanner for scanning and reading still images, and a video capture for inputting video signals of still image or moving image, and the like, and an output device 102 such as a display for outputting a message, a printer, a speaker, etc. An output controller 103 controls the data output to the output device 102. A transmission data holding unit 106 holds the message to be transmitted, and a received data holding unit 107 holds the received message.

An electronic news data storage 121 manages all the messages including the posted message, reply, etc.

A reply data manager unit 108 manages data for a fixed form reply such as “yes, it is”, “I agree”, “no, it isn't”, “I disagree” and the like, by the reply numbers R-1, R-2, R-3, . . . respectively. As the data for a fixed form reply, there are stored text data in a text storage 109, still picture data in a still picture storage 110, speech sound data in the speech sound storage 111, and moving picture data in a moving picture storage 112, respectively.

A main controller 104 controls the operation of each part of the client apparatus 100 and the receipt and delivery of the data between the parts.

### Embodiment 2

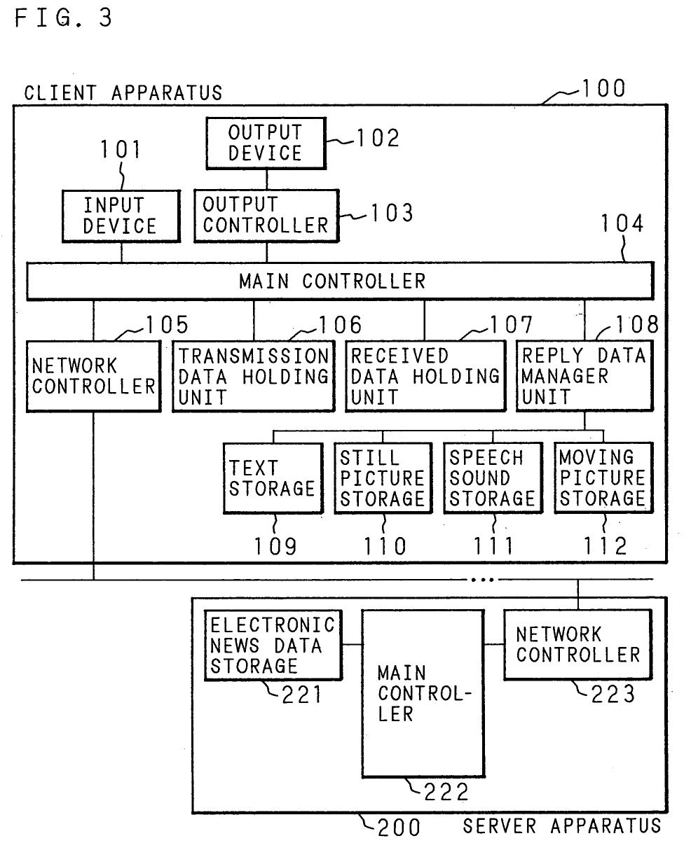

FIG. 3 is a constitution view of an example of the client/server type electronic news system of the present invention. The same parts as those of Embodiment 1 are indicated with the same numerals and their explanations omitted.

The client apparatus 100 and the server apparatus 200 are connected by the computer network such as a personal computer communication network, the Internet, and the like, and the client apparatus 100 and the server apparatus 200 are connected to the network through network controllers 105, 223, respectively, for controlling the communication with the network.

In this embodiment, a reply data manager unit 108 is disposed in the client apparatus 100, and an electronic news data storage 221 for managing the messages posted from the client apparatus 100 and other server apparatus and fixed form reply data are disposed in the server apparatus 200.

The transmission data holding unit 106 of the client apparatus 100 holds the message to be transmitted, and converts multimedia data into data with format receivable by the server apparatus 200.

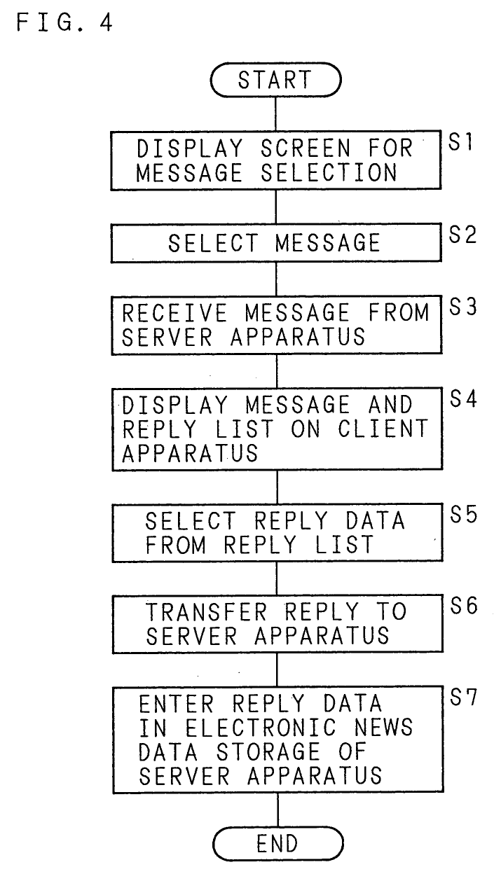

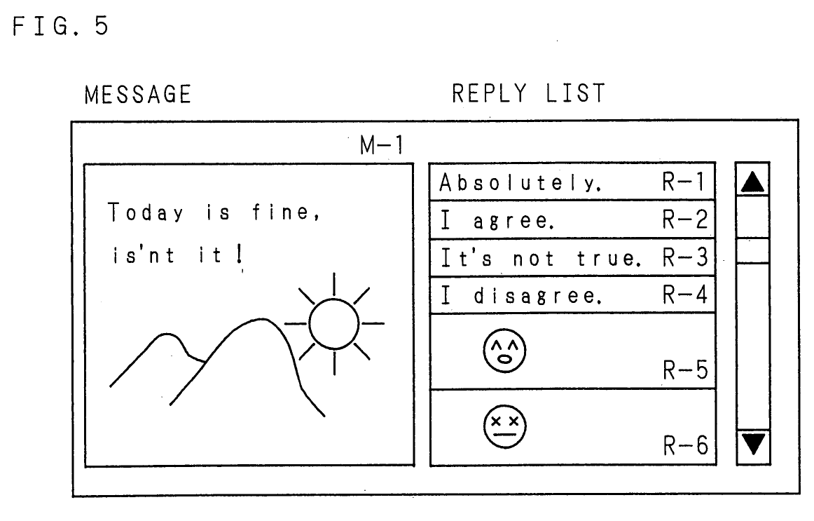

Next, the procedures in Embodiment 2 are explained on the basis of the flow chart of FIG. 4 and the example of screen display in FIG. 5. The procedures in Embodiment 1 are basically the same, except that the operations applied to the server apparatus 200 in Embodiment 2 are applied to the own system.

On the display of the output device 102, an electronic news message selection screen is displayed (Step S1). When the user selects a message (in this embodiment, Message M-1) (Step S2), the event that the message has been selected is transferred from the network controller 105 to the server apparatus 200.

The server apparatus 200 fetches the message data selected by the user from the electronic news data storage 221, and transmits the message to the selecting client apparatus 100 through the network controller 223. When the network controller 105 of the client apparatus 100 receives the message (Step S3), the received data are transferred to the received data holding unit 107.

Next, the contents of the message are transferred to the output controller 103, where the message M-1 is displayed on the display of the output device 102. With the display of the message M-1, the reply data manager unit 108 reads out the text data for a fixed form reply which is previously stored in the text storage 109 or the selected text data which fits said message out of the text data for plural fixed form replies and deliver it to the output controller 103. The output controller 103 displays the list of the text data for a fixed form reply on the display of the output device 102 (Step S4) (ref. FIG. 5).

When the user selects the reply data out of the displayed text data for a fixed form reply by using the input device 101 such as the keyboard, mouse, etc. (Step S5), the transmission data holding unit 106 buries data which is indicative of the reply to the original message M-1 in the header of the selected reply data to prepare message data for transmitting to the server apparatus 200, and said message data is transferred to the server apparatus 200 through the network controller 105 (Step S6). The server apparatus 200 analyzes the header of the message data received by the network controller 223, and enters it in the electronic news data storage 221 as the reply to the original message M-1 in relation to the message (Step S7).

In case of referring to the reply data, the same processing as in the steps S1-S3 may be made, by which the reply entered in relation to the message M-1 selected by the user, along with said message M-1, is displayed on the output device 102 of the client apparatus 100. In this case, only the reply may be displayed without displaying the original message M-1.

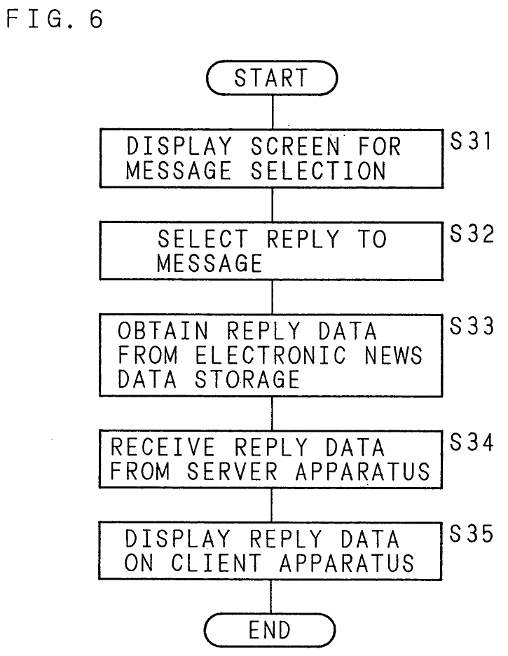

The procedures in the above case are explained on the basis of the flow chart of FIG. 6.

An electronic news message selection screen is displayed on the display of the output device 102 (Step S31). The message selection screen is provided with a button for displaying the message in relation to the message name and a button for displaying the reply. When the user selects a reply button for the message calling for the reference to the reply (in this embodiment, the message M-1) (Step S32), the event that the reply of the message M-1 has been selected is transmitted to the server apparatus 200 through the network controller 105.

The server apparatus 200 obtains the reply data entered in relation to the message data selected by the user from the electronic news data storage 221 (Step S33), and transfers it to the client apparatus 100 which required the reference of the reply, through the network controller 223. When the network controller 105 of the client apparatus 100 receives the reply data (Step S34), the received reply data is transferred to the received data storage 107. Next, the contents of the reply data are transferred to the output controller 103, and the reply data of the message M-1 is displayed on the display of the output device 102 (Step S35).

In this embodiment, explanation has been given on the case of the text data having been selected as the data for a reply, but any of the still picture, speech sound, or moving picture may be adopted as the data for a reply, or any of them may be combined to make the data for a reply.

In this embodiment, explanation has been given on the case where the message data of the selected reply data is prepared on the side of the client apparatus 100 and transmitted to the server apparatus 200. However, in case the plural client apparatus 100 respectively store the same data for a reply, only the reply numbers (R-1, R-2, R-3, . . . ) assigned individually to the data for a reply may be transmitted to the server apparatus 200 and entered in the electronic news data storage 221 in relation to the original message M-1.

### Embodiment 3

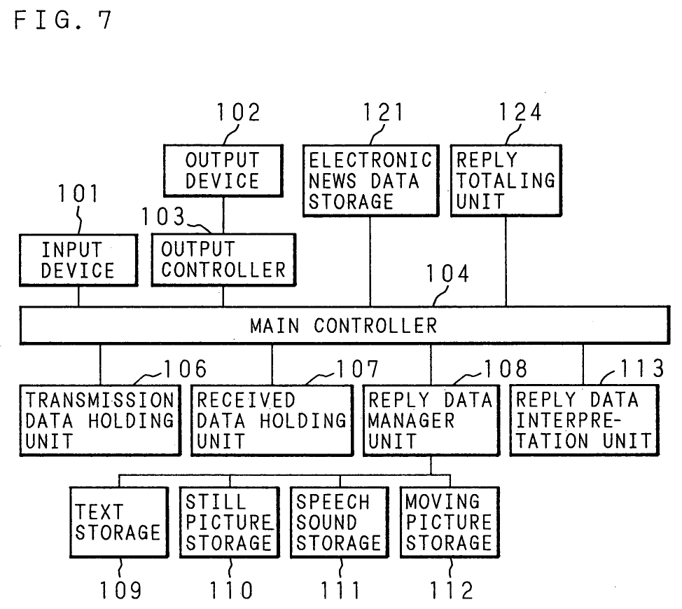

FIG. 7 shows a constitution view of another embodiment of the stand-alone type electronic news system of the present invention. The same parts as those of Embodiment 1 are indicated with the same numerals and their explanations omitted.

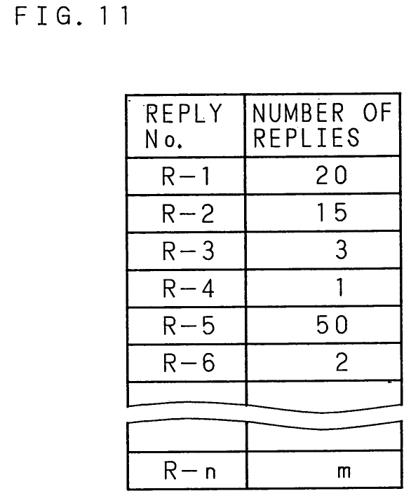

In this embodiment, in addition to Embodiment 1, there is provided a reply totaling unit 124 for counting up the number each time the reply data is selected as the reply to the message and totaling the number of the selection by utilizing the reply number assigned to data for a fixed form reply. A reply data interpretation unit 113 stores the results of the totalization by the reply number in the table style (ref. FIG. 11).

### Embodiment 4

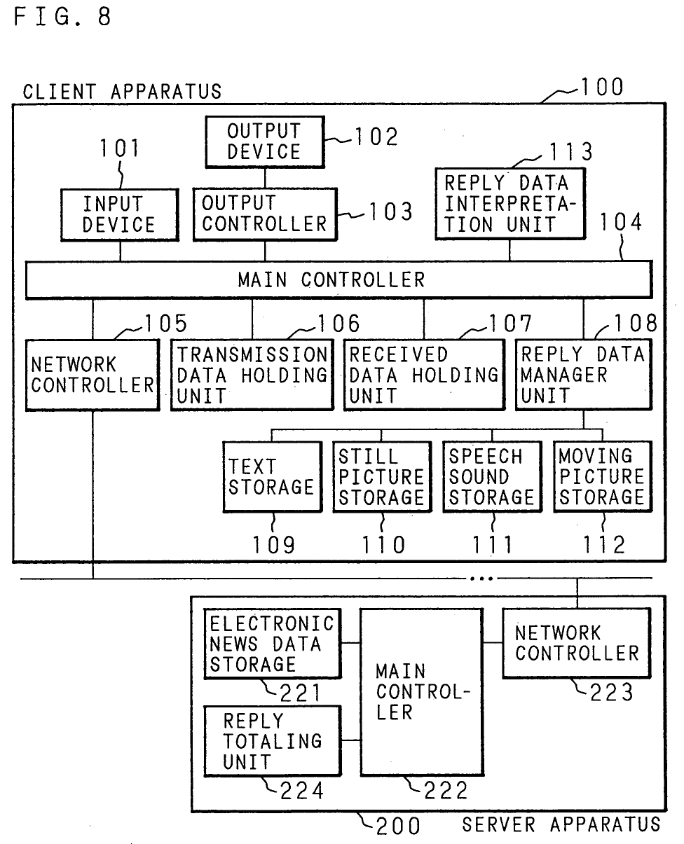

FIG. 8 shows a constitution view of another embodiment of the client/server type electronic news system of the present invention. The same parts as those of Embodiments 1 and 2 are indicated with the same numerals and their explanations omitted.

In this embodiment, plural client apparatus 100 respectively store the same data for a reply, the client apparatus 100 is provided with a reply data interpretation unit 113, and the server apparatus 200 with a reply totaling unit 224.

The transmission data holding unit 106 of the client apparatus 100 holds the message to be transmitted, and converts multimedia data into the receivable format data by the server apparatus 200. In case of the transmission message selected from the data for a fixed form reply, the transmission message having only the reply number information is prepared.

The reply totaling unit 224 of the server apparatus 200 has a table by the reply number to the original message. When the main controller 222 judges that the received message is the one having only the reply number information, the main controller 222 counts up the number of replies of the reply numbers of the corresponding messages in the reply totaling unit 224.

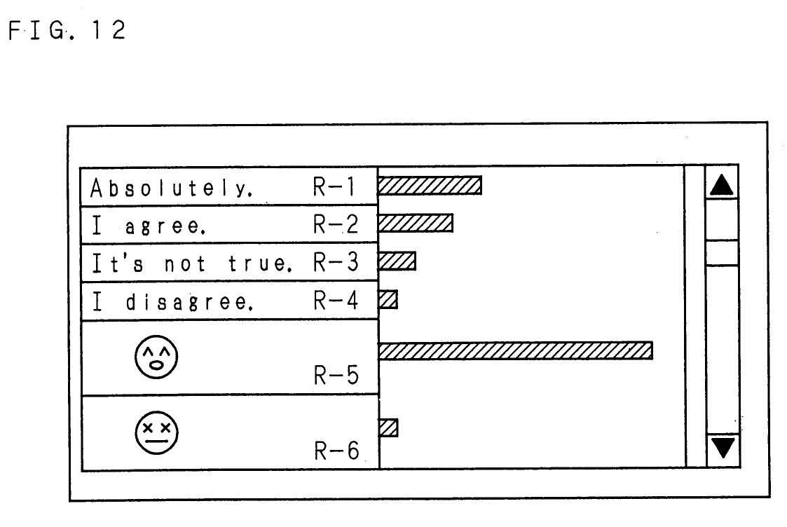

The reply data interpretation unit 113 of the client apparatus 100 manages the reply data of table form, to which the contents of the table in the reply totaling unit 224 in the server apparatus 200 are transferred through the network controller 105 of the client apparatus 100. Also, if there is a requirement for display from the user, the main controller 104 causes the output device 102 to display the totalized table form reply data managed by the reply data interpretation unit 113 on the display. At that time, the main controller 104 displays, besides the numbers of the replies, the data by processing into the form easy to refer such as a bar graph, line graph, etc., according to the user's requirements (ref. FIG. 12).

In the above manner, according to Embodiment 4, since only the reply numbers are transmitted between the client apparatus 100 and the server apparatus 200, there is no necessity to transmit the large amount of the data per se such as the multimedia data, thereby to alleviate the network load.

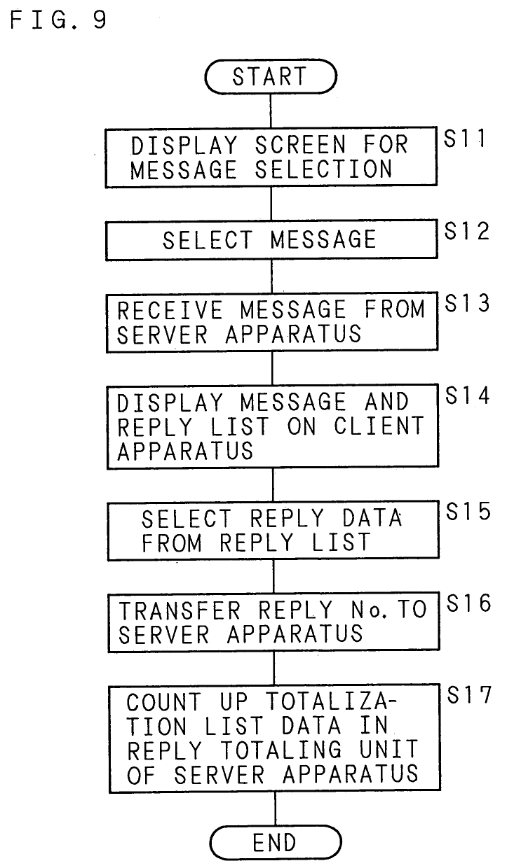

Next, the procedures in Embodiment 4 are explained on the basis of the flow chart of FIG. 9. The procedures in Embodiment 3 are basically same as those of Embodiment 4 except that the operations to the server apparatus 200 made in Embodiment 4 are applied to the own system.

On the display of the output device 102, an electronic news message selection screen is displayed (Step S11). When the user selects a message (in this embodiment, M-1) (Step S12), the event that the message has been selected is transmitted from the network controller 105 to the server apparatus 200.

The server apparatus 200 obtains the message data selected by the user from the electronic news data storage 221, and transfer the message from the network controller 223 to the client apparatus 100 which has selected the message. When the network controller 105 of the client apparatus 100 receives the message (Step S13), the received data is transferred to the received data holding unit 107.

Next, the contents of the message are transferred to the output controller 103, and the message M-1 is displayed on the display of the output device 102. With the display of the message M-1, the reply data manager unit 108 reads out the selecting text data relating to the message from text data for a fixed form reply stored in advance in the text storage 109 or from text data of plural fixed form replies and delivers it to the output controller 103. The output controller 103 displays the list of the text data for a fixed form reply on the display of the output device 102 (Step S14).

When the user, using the input device 101 such as a keyboard or mouse, selects reply data out of the displayed text data for a fixed form reply (Step S15), the transmission data holding unit 106 prepares message data having only the reply number information of the selected reply data, and this message data is transferred from the network controller 105 to the server apparatus 200 (Step S16). When the main controller 222 of the server apparatus 200 recognizes that the message data received by the network controller 223 is the reply having only the reply number information, the main controller 222 counts up the numerical values corresponding to the reply number on the table by reply number of each message stored in the reply totaling unit 224 (ref. FIG. 11) (Step S17).

In case of referring to the message of reply, the processing as in the steps S11-S13 may be made, by which the message M-1 selected by the user is displayed on the display of the output device 102 of the client apparatus 100. Next, the contents of the table stored in the reply totaling unit 224 of the server apparatus 200 are transferred to the reply data interpretation unit 113 through the network controller 105 of the client apparatus 100. The reply data interpretation unit 113 manages the reply data of table form, wherein the main controller 104 transfers the reply data in the table form to the output controller 103 responsive to the display requirement, and the totalized reply data of table form is displayed on the display of the output device 102, for example, in a bar graph style, as shown in FIG. 12.

In this case, only the reply may be displayed without displaying the original message M-1.

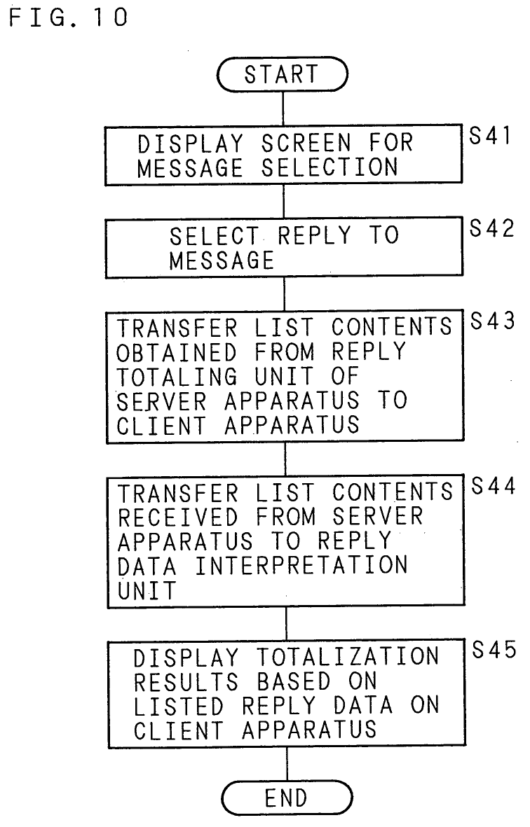

The procedures in the above case are explained on the basis of the flow chart of FIG. 10.

An electronic news message selection screen is displayed on the display of the output device 102 (Step S41). The message selection screen is provided with a button for displaying the message in relation to the message name and a button for displaying the reply. When the user selects a reply button for the message calling for the reference to the reply (in this embodiment, the message M-1) (Step S42), the event that the reply of the message M-1 has been selected is transmitted to the server apparatus 200 from the network controller 105.

The server apparatus 200 fetched the contents of the table of the totalization results stored in relating to the message data selected by the user from the reply totaling unit 224, and transfers them to the reply data interpretation unit 113 through the network controller 105 of the client apparatus 100 (Steps S43, S44). When the contents of the table from the server apparatus 200 are received, the main controller 104 transfers the table form reply data from the reply data interpretation unit 113 which manages the table form reply data to the output controller 103 responsive to the display requirement, where the totalized reply data is displayed on the display of the output device 102, for example, in a bar graph style as shown in FIG. 12 (Step 45).

In this embodiment, explanation has been given on the case of the text data having been selected as the data for a reply, but any of the still picture, speech sound or moving picture may be adopted as the data for a reply, or any of them may be combined to make the data for a reply.

### Embodiment 5

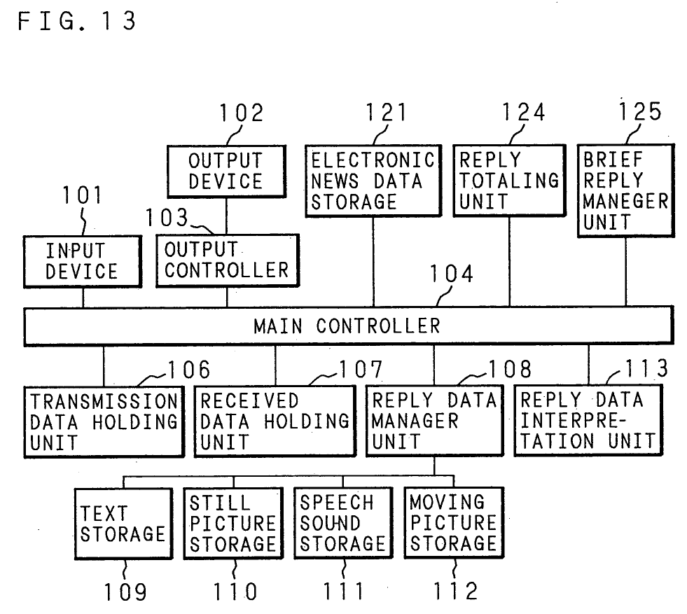

FIG. 13 shows a constitution view of another embodiment of the stand-alone type electronic news system of the present invention. The same parts as those of Embodiments 1 and 3 are indicated with the same numerals and their explanations omitted.

In this embodiment, in consideration of the occurrence of the case where the desired message cannot be sufficiently conveyed with the previously prepared data for a fixed form reply, free form replies can be made. Accordingly, in addition to Embodiment 3, there is provided a brief reply manager unit 125 for totally managing brief replies of free forms to the message.

The brief reply manager unit 125 enters the contents of the brief reply message of a free form in the table for managing the original message.

### Embodiment 6

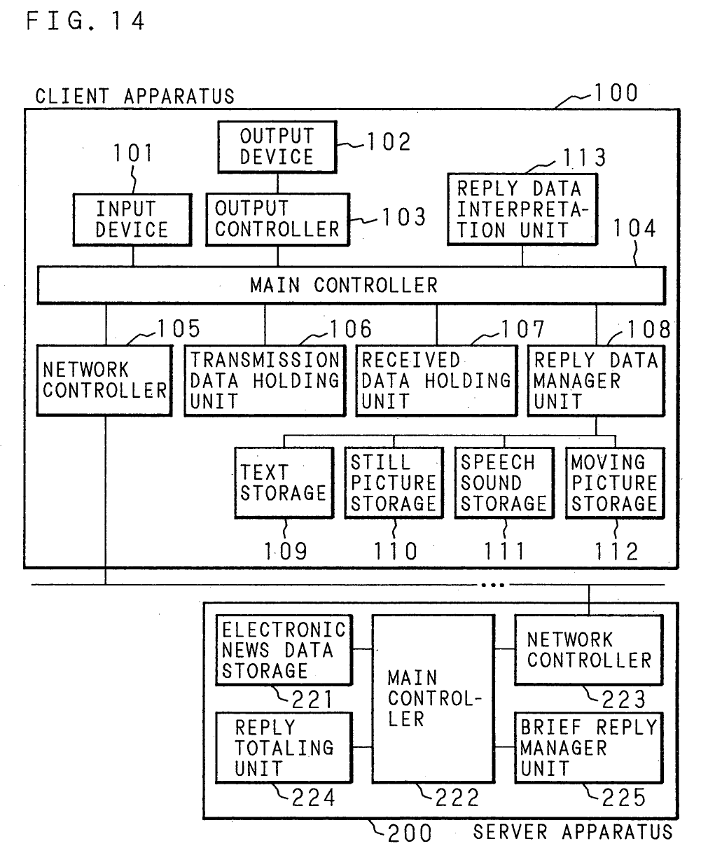

FIG. 14 shows a constitution view of another embodiment of the client/server type electronic news system of the present invention. The same parts as those of Embodiments 1, 3 and 5 are indicated with the same numerals and their explanations omitted.

In this embodiment, the server apparatus 200 is provided with a brief reply manager unit 225, so that the contents of the brief reply message of a free form are entered in the table for managing the original message.

Next, the procedures in Embodiment 6 are explained. The procedures in Embodiment 3 are basically the same, except that the operations applied to the server apparatus 200 in Embodiment 6 are applied to the own system.

Since the procedures up to the display of the message on the display of the output device 102, are same as those of Embodiments 2 and 4, explanation thereof is omitted.

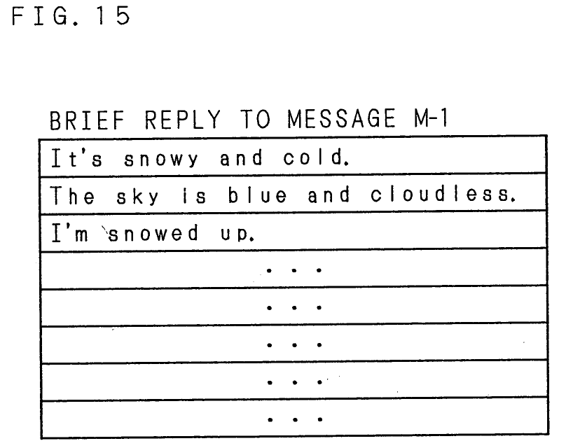

When the user inputs a text to the message displayed on the display by using the input device 101 such as the keyboard or mouse, the transmission data holding unit 106 prepares a reply message. This message data is transferred to the server apparatus 200 from the network controller 105. The main controller 222 of the server apparatus 200 transfers the reply message received by the network controller 223 to the brief reply manager unit 225. The brief reply manager unit 225 enters the contents of the reply message of a free form in the table for managing the reply of the original message (ref. FIG. 15).

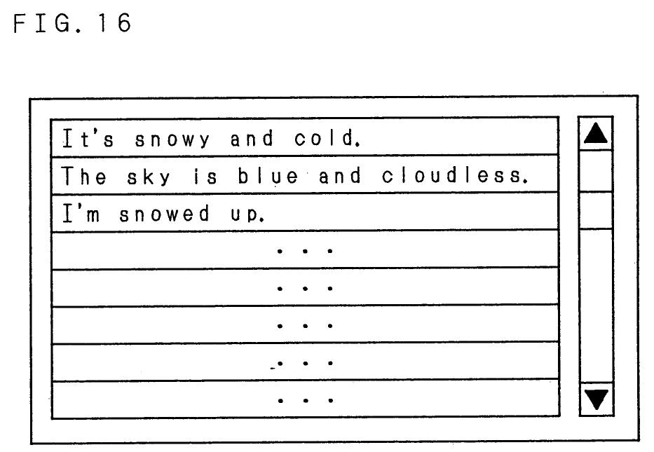

In case of referring to the brief reply message, when the message selected by the user is displayed on the display of the output device 102 of the client apparatus 100, the contents of the table stored in the brief reply manager unit 225 of the server apparatus 200 are transferred to the reply data interpretation unit 113 through the network controller 105 of the client apparatus 100. The reply data interpretation unit 113 manages also the brief reply data of a free form in a table form, wherein the main controller 104 transfers the brief reply data in the table form from the unit 113 to the output controller 103 responsive to the display requirement, and the brief reply data is displayed in a table form on the display of the output device 102, as shown, for example, in FIG. 16.

In this case, only the reply may be displayed without displaying the original message.

In this embodiment, explanation has been given on the case of the text data having been selected as the data for a reply, but any of the still picture, speech sound, or moving picture may be adopted as the data for a reply, or any of them may be combined to make the data for a reply.

### Embodiment 7

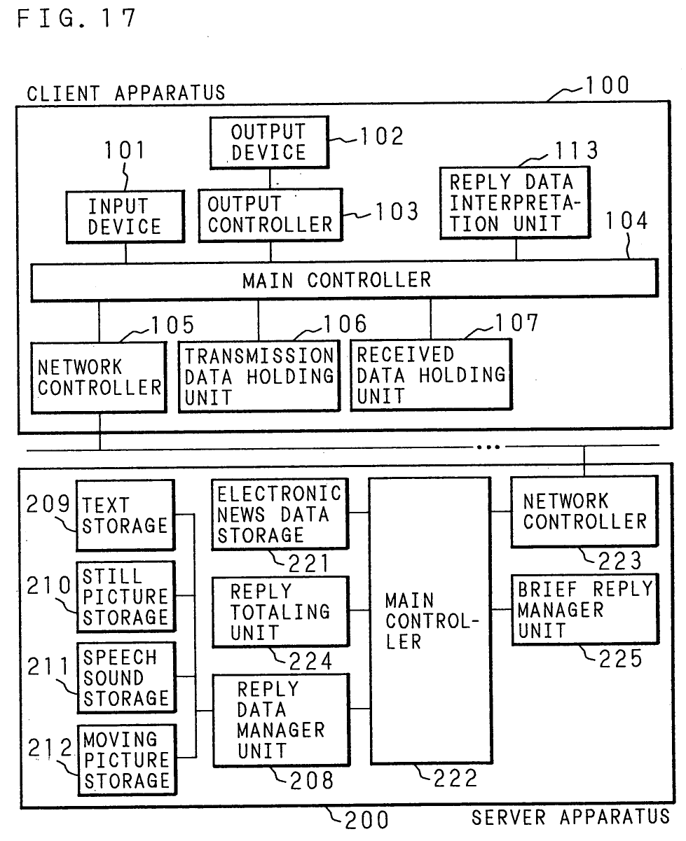

FIG. 17 shows a constitution view of another embodiment of the client/server type electronic news system of the present invention. The same parts as those of Embodiments 2, 4 and 6 are indicated with the same numerals and their explanations omitted.

In this embodiment, there are provided a text storage 209 for storing data for a fixed form reply, still picture storage 210, speech sound storage 211 and moving picture storage 212, and reply data manager unit 208 for managing the data for a reply in the server apparatus 200. Due to the holding of the data for a fixed form reply by the server apparatus 200, changes of the number, pattern, etc. thereof are facilitated.

This embodiment can be utilized for the case of selecting the data for a reply which fits the contents of the news out of numbers of data for a reply and presenting the selected data to the user. As the means for selecting the data for a reply, there may be a method of making selection based on the category of the news categorized by topics, for example, or providing the news in advance with the reply number of the data for a fixed form reply.

Next, the procedures in Embodiment 7 are explained.

On the display of the output device 102, an electronic news message selection screen is displayed. When the user selects a message, the event that the message has been selected is transferred from the network controller 105 to the server apparatus 200.

The server apparatus 200 fetches the message data selected by the user from the electronic news data storage 221, and causes the reply data controller 208 to fetch the data for a fixed form reply which fits to category of the selected message from the text storage 209, for example, and then transfers the message data and the data for a fixed form reply from the network controller 223 to the client apparatus 100 which has selected the message.

When the network controller 105 of the client apparatus 100 receives the message and the data for a reply, the received data is transferred to the received data holding unit 107.

Next, the message and the data for a reply is delivered to the output controller 103, and the output controller 103 displays the list of the text data for fixed form replies along with the message on the display of the output device 102.

Since the procedures up to the stage of entering the selected data for a reply in the electronic news data storage 221 of the server apparatus 200 are same as those of Embodiment 2, explanation thereof is omitted.

In this embodiment, explanation has been given on the case of the text data having been selected as the data for a reply, but any of the still picture, speech sound, or moving picture may be adopted as the data for a reply, or any of them may be combined to make the data for a reply.

### Embodiment 8

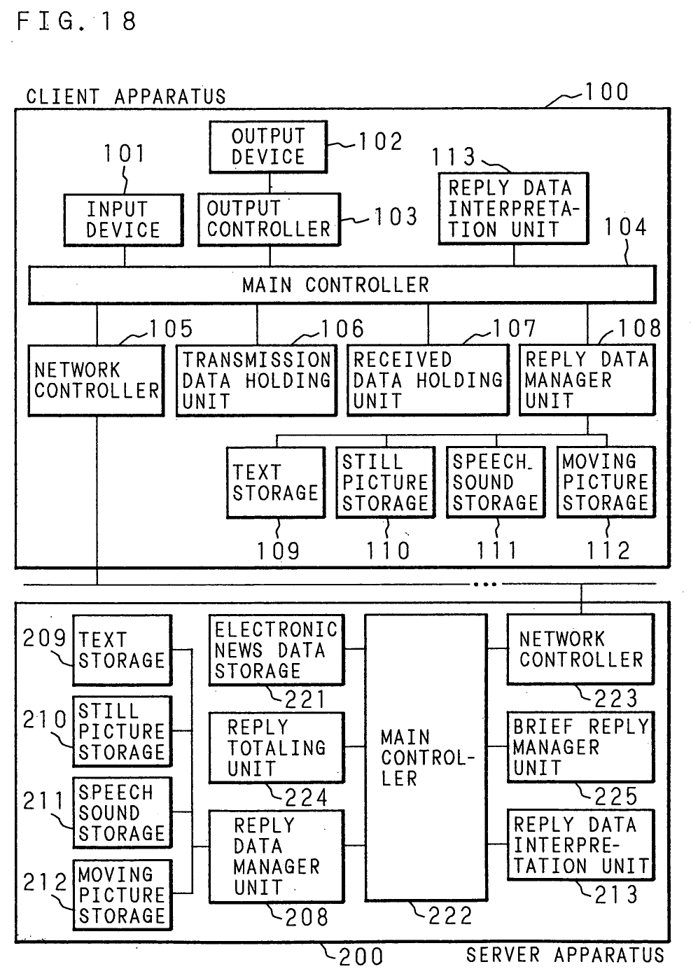

FIG. 18 shows a constitution view of another embodiment of the client/server type electronic news system of the present invention. The same parts as those of Embodiments 2 and 7 are indicated with the same numerals and their explanations omitted.

In this embodiment, the standard data for a fixed form reply common to the news of various categories are stored in the client apparatus 100, and other non-standard data for a fixed form reply peculiar to the individual categories are stored in the server apparatus 200. According to the category of the news, the data per se of the non-standard data for a fixed form reply peculiar to the category is transmitted to the client apparatus 100, but the standard data for a fixed form reply common to many categories need not be transmitted to the client apparatus 100.

Next, the procedures in Embodiment 8 are explained.

On the display of the output device 102, an electronic news message selection screen is displayed. When the user selects a message, the event that the message has been selected is transferred from the network controller 105 to the server apparatus 200.

The server apparatus 200 fetches the message data selected by the user from the electronic news data storage 221, and causes the reply data manager unit 208 to fetch the non-standard data for a fixed form reply peculiar to the category of the selected message from the text storage 209, for example and then transfers the message data and the non-standard data for a fixed form reply from the network controller 223 to the client apparatus 100 which has selected the message.

When the network controller 105 of the client apparatus 100 receives the message and the data for a reply, the received data is transferred to the received data holding unit 107.

Next, the message, non-standard data for a reply, and standard data for a reply fetched from the text storage 109 of the client apparatus 100 is delivered to the output controller 103, and the output controller 103 displays the list of the standard and non-standard text data for a fixed form reply along with the message on the display of the output device 102.

When the user, using the input device 101 such as a keyboard or mouse, selects the reply data out of the displayed standard/non-standard text data for fixed form replies, the transmission data holding unit 106 prepares of message data having only the reply number information of the selected reply data, and this message data is transferred from the network controller 105 to the server apparatus 200. When the main controller 222 of the server apparatus 200 recognizes that the message data received by the network controller 223 is the reply having only the reply number information, the main controller 222 counts up the numerical values corresponding to the reply number on the table by reply number of each message stored in the reply totaling unit 224.

Since the procedures up to the stage of entering the selected data for a reply in the electronic news data storage 221 of the server apparatus 200 are same as those of Embodiments 2 and 4, explanation thereof is omitted.

In this embodiment, explanation has been given on the case of the text data having been selected as the data for a reply, but any of the still picture, speech sound or moving picture may be adopted as the data for a reply, or any of them may be combined to make the data for a reply.

As this invention may be embodied in several forms without departing from the spirit of essential characteristics thereof, the present embodiment is therefore illustrative and not restrictive, since the scope of the invention is defined by the appended claims rather than by the description preceding them.

1. An electronic news system for managing an electronic message having a message content and a reply to said message, comprising:
storage means for storing plural fixed form replies inputted in advance of the electronic message, stored separately from the electronic message and having reply contents independent of the message content of the electronic message allowing use of said plural fixed form replies with other electronic messages;
input means for inputting the electronic message without information about a reply to said message;
output means for outputting the message with said plural fixed form replies to the message retrieved from said storage means, said plural fixed form replies independent of the message; and
control means for accepting a selected fixed form reply out of the outputted plural fixed form replies as the reply to the message.

2. An electronic news system according to claim 1, further comprising:
fixed form reply managing means for managing a plurality of fixed form replies by data for respectively specifying said plurality of replies, and
totaling means for totaling a number of the selections of each of fixed form replies as the reply to the message, and storing results of the totalization of each of fixed form replies to the message in relation to said specifying data.

3. An electronic news system according to claim 1, wherein said control means has means for accepting an input of a free form reply to the message, and managing the inputted free form reply in relation to data to specify said message.

4. An electronic news system according to claim 2, wherein said control means has means for accepting an input of a free form reply to the message, and managing the inputted free form reply in relation to data to specify said message.

5. An electronic news system according to claim 1, wherein said fixed form reply is one kind or the combination of plural kinds of data selected from a plurality of kinds including text, still picture, speech, sound and moving pictures.

6. An electronic news system according to claim 1, wherein said control means includes means for causing said output means to output data for a fixed form reply of the kind which fits contents of the message.

7. An electronic news system including a client apparatus and a server apparatus which manages an electronic message having a message content and a reply to said message transmitted from the client apparatus, said client apparatus comprising:
storage means for storing plural fixed form replies, inputted in advance of the message and stored separately from the electronic message and having reply contents independent of the content of the electronic message allowing use of said plural fixed form replies with other electronic messages;
input means for inputting the electronic message without information about a reply to said message;
output means for outputting the message with said plural fixed form replies to the message retrieved from said storage means, said plural fixed form replies being independent of the message;
control means for accepting a selected fixed form reply out of the outputted plural fixed form replies as the reply to the message; and
communication control means for transmitting the selection to the server apparatus.

8. An electronic news system according to claim 7, wherein the client apparatus comprises means for accepting an input of a free form reply to the message in said control means, and the server apparatus comprises free form reply managing means for managing the free form reply transmitted from the client apparatus in relation to data for specifying said message.

9. An electronic news system including a client apparatus and a server apparatus which manages electronic messages having corresponding message content and transmitted from the client apparatus, comprising:
said server apparatus comprising:
storage means for storing plural fixed form replies, inputted in advance of the electronic messages and stored separately from the electronic messages and having reply contents independent of the message content of the electronic message allowing use of said plural fixed form replies with other electronic messages;
communication control means for transmitting said plural fixed form replies to the client apparatus;
said client apparatus comprising:
receiving control means for receiving said plural fixed form replies sent from the server apparatus, said plural fixed form replies independent of the electronic messages;
input means for inputting the electronic message without information about a reply to said message;
output means for outputting the message with said plural fixed form replies to the message;
control means a selected fixed form reply out of the outputted plural form replies as the reply to the message; and
transmission control means for controlling the transmission for transmitting the selected reply to the server apparatus.

10. An electronic news system according to claim 9, wherein the client apparatus comprises fixed form reply managing means for managing a plurality of fixed form replies by data for respectively specifying said plurality of replies, and communication control means for transmitting specifying data of the selected reply to the server apparatus as a reply, and the server apparatus comprises communication control means for receiving the specifying data transmitted from the client apparatus as a reply, and totaling means for totaling a number of the selections of each reply as the reply to the message based on said specifying data, and storing the results of the totalization of each reply to said message in relation said specifying data.

11. An electronic news system according to claim 9, wherein the client apparatus comprises means for accepting an input of a free form reply to the message in said control means, and the server apparatus comprises free form reply managing means for managing free form reply transmitted from the client apparatus in relation to data for specifying said message.

12. An electronic news system according to claim 10, wherein the client apparatus comprises means for accepting an input of a free form reply to the message in said control means, and the server apparatus comprises free form reply managing means for managing the free form reply transmitted from the client apparatus in relation to data for specifying said message.

13. An electronic news system including a client apparatus and a server apparatus which manages an electronic message having a message content and a reply to said message transmitted from the client apparatus,
said server apparatus comprising:
storage means for storing a first set of plural fixed form replies, stored separately from the electronic message, independent from the electronic message, and inputted in advance of the message and having reply contents independent of the message content of the electronic message allowing use of the first set of plural fixed form replies with other electronic messages;
communication control means for transmitting for the first set of plural fixed form replies to the client apparatus,
said client apparatus comprising:
receiving control means for receiving the first set of plural fixed form replies sent from the server apparatus;
storage means for storing a second set of plural fixed form replies, stored separately from the message;
input means for inputting the electronic message without information about a reply to said message;
output means for outputting the message with the first set of plural fixed form replies or the second set of plural fixed form replies;
control means for accepting a selected fixed form reply out of the outputted the first set of plural fixed form replies or the second set of plural fixed form replies based on the category of the message as the reply to the message; and
means for controlling the transmission for transmitting the selected reply out of the first set of plural fixed form replies or the second set of plural fixed form replies to the server apparatus.

14. An electronic news system according to claim 13, wherein the server apparatus comprises fixed form reply managing means for managing a plurality of first fixed form replies with data for respectively specifying said replies, and means for transmitting the specifying data of the first fixed form reply to the client apparatus along with said reply,
the client apparatus comprises fixed form reply managing means for managing a plurality of second fixed form replies with the data for respectively specifying said replies, and means for causing said transmission controlling means to transmit the selected second reply or the selected specifying data of the first reply to the server apparatus as a reply,
said server apparatus further comprises means for transmitting specifying data of the second fixed form reply to the client apparatus, and means for receiving the second reply or specifying data of the first reply transmitted from the client apparatus as a reply in said communication control means, and totaling means for totaling a number of the selections of each reply as the reply to the message based on said specifying data, and storing the results of the totalization of each reply to said message in relation said specifying data,
said client apparatus further comprises means for receiving the specifying data of the second fixed form reply sent from the server apparatus in said receiving control means, and means for outputting the stored second fixed form reply based on said specifying data in said output means.

15. An electronic news system according to claim 13, wherein the client apparatus comprises means for accepting an input of a free form reply to the message in said control means, and the server apparatus comprises free form reply managing means for managing the free form reply transmitted from the client apparatus in relation to data for specifying said message.

16. An electronic news system according to claim 14, wherein the client apparatus comprises means for accepting an input of a free form reply to the message in said control means, and the server apparatus comprises free form reply managing means for managing the free form reply transmitted from the client apparatus in relation to the data for specifying said message.

17. A recording medium readable by a computer which manages an electronic message having a message content and a reply to said message, comprising:
program code means for causing said computer to store plural fixed form replies in said computer, the plural fixed form replies being stored in advance of the electronic message and separately from the electronic message and having reply contents independent of the content of the electronic message allowing use of said plural fixed form replies with other electronic messages;
program code means for inputting the electronic message without information about a reply to said message;
program code means for causing said computer to output the message with data for plural fixed form replies a reply to the message, said plural fixed form replies for a reply independent of the message; and
program code means for causing said computer to accept a selected fixed form reply which fits the electronic message out of the outputted plural fixed forms replies as the reply to said message.

18. A recording medium according to claim 17, further comprising:
program code means for causing said computer to manage a plurality of fixed form replies with data for respectively specifying said replies; and
program code means for causing said computer to total a number of the selections of each reply as the reply to the message and store the results of totaling the totalization of each reply to said messages in relation to said specifying data.

19. A recording medium according to claim 17, further comprising:
program code means for causing said computer to accept an input of a free form reply to the message; and
program code means for causing said computer to manage the inputted free form reply in relation to data for specifying said message.

20. A recording medium according to claim 18, further comprising:
program code means for causing said computer to accept an input of the free form reply to the message; and
program code means for causing said computer to manage the inputted free form reply in relation to data for specifying said message.

21. A message system for an electronic message having a message content, comprising:
a reply data storage device storing plural fixed form replies, each of the plural fixed form replies containing replies having reply contents independent of the message content of the electronic message allowing use of the plural of fixed form replies with other electronic messages;
an input device for inputting the electronic message without information about a reply to said message;
a controller receiving the message from a host and allowing a user to retrieve a reply out of the plural fixed form replies stored in the reply data storage device, the plural fixed form replies being independent of the message, inputted in advance of the message, and stored separately from the message; and
an output device outputting the selected reply to the host.

22. The message system as recited in claim 21 wherein, the controller selects a fixed form reply based on a category of the message.

23. The message system as recited in claim 21 wherein, the reply can include video or audio data.

24. The message system as recited in claim 21 wherein, the host receives a plurality of the outputted selected fixed form replies and displays a bar graph illustrating a frequency of responses.

25. A computer readable storage medium storing a computer program instructing a computer to perform operations for an electronic message having a message content, comprising:
storing plural fixed form replies containing a plurality of replies and contents independent of the content of the electronic message allowing use of the plural fixed form replies with other electronic messages;
inputting the electronic message without information about a reply to said message;
storing the message separately from the plural fixed form replies, the message being inputted after the plural fixed form replies;
receiving the message from a host;
selecting a fixed form reply from the plural fixed form replies independent of the message;
allowing a user to choose a reply from the selected fixed form reply out of the plural fixed form replies;
sending the chosen reply to the host; and
computing the frequency of chosen replies sent to the host.

26. A method of managing an electronic message having a message content and reply choices to the electronic message, comprising:
storing plural fixed form replies in advance of the electronic message and the replies having reply contents independent of the message content of the electronic message allowing use of the said plural fixed form replies with other electronic messages;
outputting the electronic message with said plural fixed form replies; and
selecting, subsequent to inputting the electronic message, certain of the outputted fixed form replies out of the outputted plural fixed form replies as the reply choices to the message.

27. The method according to claim 26, further comprising:
managing the plural fixed form replies by data respectively specifying the plural fixed form replies;
totaling a number of the selections of each of the plural fixed form replies as the reply choices to the message; and
storing results of the totalization of each of the plural fixed form replies to the message in relation to the specifying data.

28. A method of managing electronic messages having message content, comprising:
storing replies for the electronic messages with the replies having reply contents independent of the message content allowing use of the replies with more than one of the messages;
receiving the electronic message and presenting the electronic message to a recipient;
presenting the replies to the recipient and allowing the recipient to select one of the replies out of the presented replies; and
sending the selected one of the replies.

29. A method of managing a reply to electronic messages having corresponding message content, comprising:
pre-creating content independent reusable plural fixed form replies, the plural fixed form replies being freely assignable to a received electronic message; and
allowing a recipient of the electronic message to assign one of the plural fixed form replies as reply to the electronic message.

30. An electronic news system for managing an electronic message having a message content and a reply, comprising:
storing plural fixed form replies independent of the content of a first electronic message;
sending the first electronic message;
selecting any one of the stored plural fixed form replies including fixed form replies having contents independent of the message content of the first electronic message;
sending a second electronic message; and
selecting any one of the stored plural fixed form replies independent of a message content of the second electronic message.

31. A method for managing electronic messages, comprising:
retrieving stored selectable fixed form replies upon receiving an electronic message, the selectable fixed form replies being freely assignable to the electronic messages including electronic messages unrelated thereto; and
displaying the received electronic message with a selected fixed form reply among the retrieved selectable fixed form replies, where a desired reply from the selectable fixed form replies is selected as a reply choice to the received electronic message.
